(19) United States
(12) Patent Application Publication
(10) Pub. No.: US 2013/0074275 A1
(43) Pub. Date: Mar. 28, 2013

(54) HAND TOOL

(71) Applicant: Edward Joseph Barberio, Miami Beach, FL (US)

(72) Inventor: Edward Joseph Barberio, Miami Beach, FL (US)

(21) Appl. No.: 13/625,834

(22) Filed: Sep. 24, 2012

Related U.S. Application Data
(60) Provisional application No. 61/538,037, filed on Sep. 22, 2011.

(51) Int. Cl. A01B 1/20

(52) U.S. Cl. 7/116

(57) ABSTRACT

A hand tool solves the problem of making neat squared holes necessary in archaeology while facilitating removal of buried artifacts. The tool reduces the need for multiple/additional tools. The tool also helps prevent its loss in the work environment through its brightly colored handle, which makes it highly visible in muddy conditions. The tool includes a saw-toothed edge for cutting larger roots, sharpened notches for cutting small roots, rope and twine, and a sharp edge for shaving the soil with precision. The blade can be offset from the handle to provide an ergonomic, ambidextrous design that allows the tool to be maneuvered while in use.

### CROSS-REFERENCE TO RELATED APPLICATION

This application claims the benefit of priority of U.S. provisional application No. 61/538,037, filed Sep. 22, 2011, the contents of which are herein incorporated by reference.

### BACKGROUND OF THE INVENTION

The present invention relates to hand tools and, more particularly, to an archaeological tool to move/remove soils/sand/dirt and for cutting roots while searching for artifacts.

Tools for archaeologists are limited. Archaeologists have used mason's brick trowels and small garden shovels for moving/removing soils in dug holes while searching for artifacts. The design of these tools does not take the needs of the archaeologist in mind.

Mason's trowels are not sharpened for cutting/shaping squared holes. Archaeologist often grind edges on these trowels for this purpose. These trowels also do not have root cutting capability, are not brightly colored, and have a pointed/triangular shape. Also, the point of the trowel does not facilitate making neat, squared edges necessary in archaeology.

As can be seen, there is a need for an improved tool for archaeologists for moving/removing soils, sand and dirt as well as for cutting roots while searching for artifacts.

### SUMMARY OF THE INVENTION

In one aspect of the present invention, a hand tool comprises a handle; a blade; an offset arm interconnecting the handle with the blade; a saw-tooth edge along at least one side of the blade; a sharpened edge along at least one side of the blade; and at least one notched formed along at least one edge of the blade.

In another aspect of the present invention, a hand tool comprises a handle; a blade; an offset arm interconnecting the handle with the blade; a saw-tooth edge disposed along a top side of the blade; a sharpened edge along a front edge and a bottom edge of the blade; and at least one notch formed along an arm attachment side of the blade.

These and other features, aspects and advantages of the present invention will become better understood with reference to the following drawings, description and claims.

### BRIEF DESCRIPTION OF THE DRAWINGS

FIG. 1 is a side view of a hand tool according to an exemplary embodiment of the present invention;

FIG. 2 is a top view of the hand tool of FIG. 1;

FIG. 3 is an end view of the hand tool of FIG. 1; and

FIG. 4 is a side view of a hand tool according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hand tool that solves the problem of making neat squared holes necessary in archaeology while facilitating removal of buried artifacts. The tool reduces the need for multiple/additional tools. The tool also helps prevent its loss in the work environment through its brightly colored handle, which makes it highly visible in muddy conditions. The tool includes a saw-toothed edge for cutting larger roots, sharpened notches for cutting small roots, rope and twine, and a sharp edge for shaving the soil with precision. The blade can be offset from the handle to provide an ergonomic, ambidextrous design that allows the tool to be maneuvered while in use.

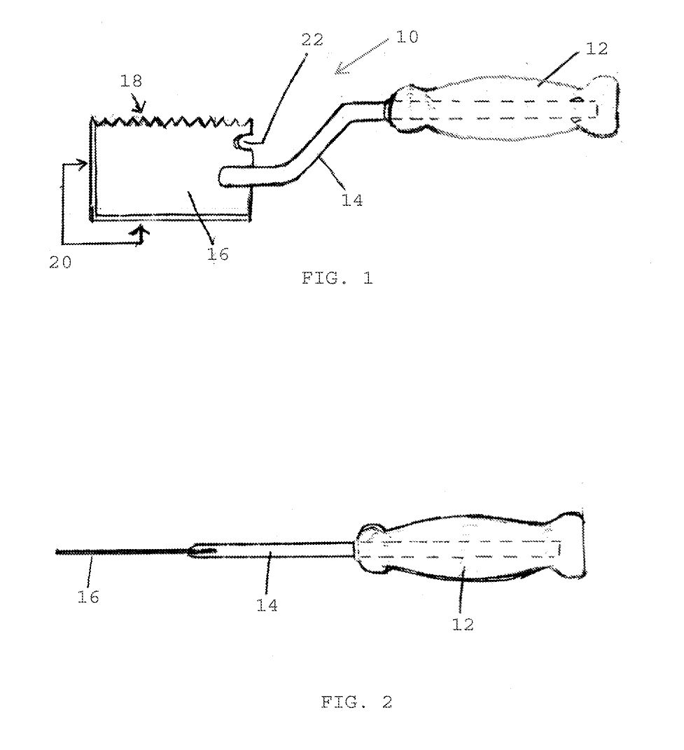

Referring to FIGS. 1 through 3, a hand tool 10 has a squared blade 16 which greatly facilitates cutting neat squared sides in precisely measured holes used by archaeologists. Sharpened edges 20 easily shave the soil with precision and the squared shape holds more soil than a conventional narrow pointed shape of a mason's trowel to facilitate soil removal.

A handle 12 of the tool 10 can connect to the blade 16 with an angled arm 14 to create a blade offset. This blade offset is ergonomically designed to make the tool 10 ambidextrous and easily maneuvered while in use. A saw-toothed edge 18 can cut through large roots often encountered in the work environment. One or more small sharpened notches 22 can be disposed in the blade 16 to cut smaller roots as well as the twine/strong used to mark/measure the holes dug. The handle 12 can be brightly colored and impact resistant that can be easily spotted in muddy field conditions. In some embodiments, the handle 12 can glow in the dark.

Other features and objects can be added to the hand tool 10 of the present invention. For example, a small tape measure can be built into or attached to the handle. A small flashlight can be incorporated into the handle. A compass could be added to the handle. A locating transmitter, can sound a signal such as a beep when the tool is mislaid.

The hand tool 10 can be made in various sizes. For example, the entire tool length can be from about 8 to about 18 inches in length, typically from about 11 to 12 inches in length. The arm 14 can provide an offset from about 2 to about 3 inches. The hand tool 10 can be made from conventional manufacturing processes.

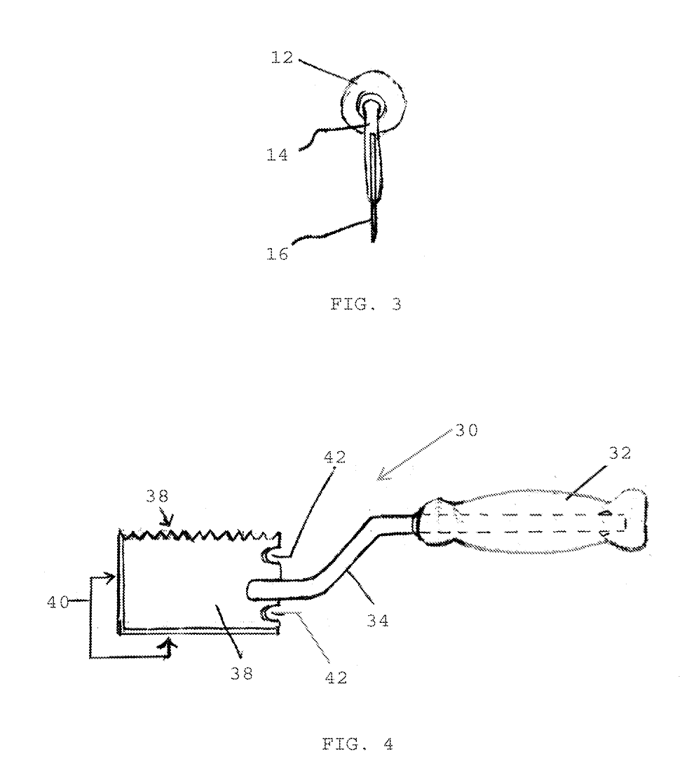

Referring to FIG. 4, a hand tool 30 can include, like the hand tool 10 of FIGS. 1 through 3, a handle 32, an offset arm 34, a blade 36, saw teeth 38, sharp blade edges 40 and first and second notches 42 cut in the blade 36, typically on opposite sides of where the offset arm 34 attached to the blade 36.

To use the hand tool 10 of the present invention, the tool can be held in either hand and used to shave, scrape or dig into the ground in a precisely measured square area usually marked by string and examining the soil and material as it is removed. The sharpened edges are used in the shaving or cutting process. The blade can be turned to its flat side to scoop and lift out soil. As the hole deepens, the right angle of the two cutting edges can be used to keep the corners nearly perfectly square. When a large root is encountered, it must be cut carefully and neatly to close the hole wall for removal. When small roots are encountered (smaller than a pencil in diameter, for example), the root is placed in the sharpened notch, pulled firmly with the free hand, and the tool is gently tugged backward to utilize the angled cutting edge in severing the root.

In the field, the tool can be used to assist the archaeologist in removing or moving soils by making it easier to cut through the soil with its sharpened edges. The tool of the present invention can replace several tools and reduce the number of tools needed. The tool of the present invention, unlike the other tools used by archaeologists, is designed for archaeologists, not for masons or gardeners. The tool of the present invention can replace the mason's trowel, the gardener's small shovel, the gardener's root pruning shears and saw, and the need of a small knife to cut twine/string used in establishing a dig area. This can speed up work by not having to switch tools or search for different tools. This can also speed up clean-up time at the end of the day as well as reduce overall costs by reducing the number of tools needed.

The tool of the present invention can be used not only by archaeologists, but also by forensic scientists, gardeners or landscapers for cutting edges, removing plants from the ground or laying squares of sod, for example.

It should be understood, of course, that the foregoing relates to exemplary embodiments of the invention and that modifications may be made without departing from the spirit and scope of the invention as set forth in the following claims.

What is claimed is:

1. A hand tool comprising:
a handle;
a blade;
an offset arm interconnecting the handle with the blade;
a saw-tooth edge along at least one side of the blade;
a sharpened edge along at least one side of the blade; and
at least one notched formed along at least one edge of the blade.

2. The hand tool of claim 1, wherein the handle is designed as a brightly colored handle for locating the hand tool in muddy field conditions.

3. The hand tool of claim 1, wherein the blade is a squared blade.

4. The hand tool of claim 1, wherein the offset arm provides an offset from about 2 to about 3 inches between the handle and the blade.

5. The hand tool of claim 1, wherein the saw-tooth edge is disposed along a top edge of the blade.

6. The hand tool of claim 1, wherein the sharpened edge is disposed along a forward edge and along a bottom edge of the blade.

7. The hand tool of claim 1, wherein the at least one notch includes two notches disposed on opposite sides of where the handle attached to the blade.

8. A hand tool comprising:
a handle;
a blade;
an offset arm interconnecting the handle with the blade;
a saw-tooth edge disposed along a top side of the blade;
a sharpened edge along a front edge and a bottom edge of the blade; and
at least one notch formed along an arm attachment side of the blade.

9. The hand tool of claim 8, wherein the at least one notch includes two notches disposed on opposite sides of where the handle attached to the blade.

10. The hand tool of claim 8, wherein the handle is designed as a brightly colored handle for locating the hand tool in muddy field conditions.

11. The hand tool of claim 8, wherein the blade is a squared blade.

12. The hand tool of claim 8, wherein the offset arm provides an offset from about 2 to about 3 inches between the handle and the blade.
